(19) United States
(12) Patent Application Publication
(10) Pub. No.: US 2005/0152269 A1
(43) Pub. Date: Jul. 14, 2005

(54) Method for MPLS link protection

(76) Inventor: Ren-Hao Liu, Hsinchu (TW)

Correspondence Address: BIRCH STEWART KOLASCH & BIRCH, PO BOX 747, FALLS CHURCH, VA, 22040-0747, US

(21) Appl. No.: 10/826,266

(22) Filed: Apr. 19, 2004

(30) Foreign Application Priority Data
Jan. 13, 2004 (TW) 93100840

(51) Int. Cl. G06F 11/00; G08C 15/00

(52) U.S. Cl. 370/225; 398/5; 714/2

(57) ABSTRACT

A method for MPLS link protection pre-builds backup LSP. When the LSP breaks down, it can redirect the LSP to the backup LSP within the minimal time and rearrange an auxiliary LSP after breaking down for a default time. By the guiding and the rearrangement, the method prevents the service of the MPLS from being unavailable when the MPLS breaks down and optimizes the utilization of the MPLS resources.

### BACKGROUND OF THE INVENTION

1. Field of Invention

The invention relates to a multi-protocol label switching (MPLS) link protection method and, in particular, to a MPLS link protection method that utilizes both pre-built and post-built backup LSP's.

2. Related Art

The main difference between a multi-protocol label switching (MPLS) network and a common IP network is in that the data transmission path of the IP network is determined by a routing table. Unless the routing table is modified, it may happen that some paths are very busy at a particular time while others are basically idle. The MPLS network uses the label to determine the routing path of a packet. Therefore, it has the function of traffic engineering. The transmission path can be controlled by modifying the packet label. It is thus very flexible in practice.

An MPLS network usually has tens of thousands of label switching paths (LSP's). This means that there are over hundreds of LSP's on a single link. When a particular link broken down, hundreds of LSP's have to be re-routed. A good re-routing mechanism has the following features: (1) low overhead, (2) efficient in bandwidth utilization, (3) short service interrupted time, and (4) high reliability. The former two features mean that the backup LSP cannot be established until the link breaks down, in order to increase the bandwidth utilization and reduce the CPU processing overhead of network devices because devices do not need to maintain backup LSP related information before link broken down. The latter two features mean that the backup LSP have to be established before the link breaks down, in order to reduce the service interrupted time and increase the reliability. Therefore, how to reconcile between these two trade off requirements in a good re-routing mechanism is an urgent topic in the field.

Some pre-built re-routing mechanisms only consider the situation of a single protected LSP, but there are over hundreds of LSP's on a single link. Moreover, a bandwidth has to be reserved for the backup LSP. Therefore, the bandwidth utilization is not optimized. When a link has a problem, the backup LSP may also not good enough because it is already a congestion link. On the other hand, dynamically building a backup LSP after a problem happens may result in long service interrupted time or failure in backup LSP building.

As disclosed in the U.S. Pat. No. 2002/0060985, the backup LSP is also built beforehand. Therefore, the utilization of the resources is low and the backup LSP may not be the best one after the link broken down.

### SUMMARY OF THE INVENTION

In view of the foregoing, the invention provides a method for multi-protocol label switching (MPLS) link protection that achieves a high bandwidth utilization, short service interrupted time, low overhead, high reliability, and optimized backup LSP.

The disclosed method first establishes a backup LSP without bandwidth reservation. Once the corresponding label switching path (LSP) breaks down, the packets thereon are redirected to the backup LSP so that the network service is not interrupted. At the same time, if the network is not fixed after a predetermined failure time (Tfail), an Ingress router rearranges an auxiliary backup LSP according to the network resources at that moment. This can increase the bandwidth utilization and lower the overhead thereon, achieving the goal of optimizing the backup LSP. After the breakdown is over, the method checks that the available time is greater than a predetermined available time (Tavailable). Then it rearranges the available paths so that the restored state is also optimized. Tfail and Tavailable are used to avoid repeated switching within a short period so that the router does not need to continuously rearrange and switch LSP's.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of default backup LSP's of the invention;

FIG. 2 is a schematic view of redirecting packets into the backup LSP's when an LSP breaks down;

FIG. 3 shows an example of the invention;

FIG. 4 is a schematic view of establishing an auxiliary backup LSP according to the invention; and

FIG. 5 is a schematic view of establishing a restored LSP according to the invention.

### DETAILED DESCRIPTION OF THE INVENTION

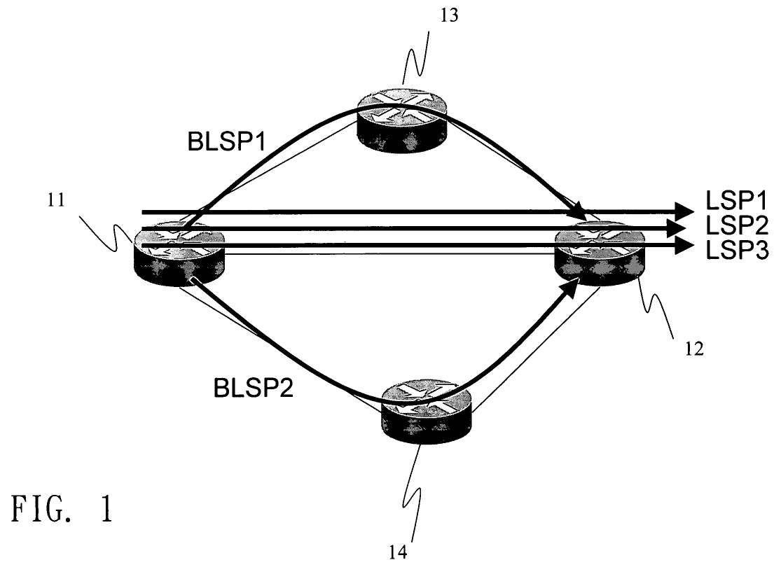

With reference to FIG. 1, the disclosed method for multi-protocol label switching (MPLS) link protection first builds several backup label switching paths (LSP) among label switching routers 11, 12, 13, 14. In order to prevent several LSP's from sharing the same backup LSP and resulting in congestion on that LSP, a parameter MaxB.W is defined to indicate the maximum bandwidth that can be transmitted over each LSP. This parameter is mainly determined by the transmission capacity of the LSP and that of the backup LSP. For example, suppose MaxB.W=5MB and the quality of service bandwidth parameters of three LSP's LSP1, LSP2 and LSP3 are 3MB, 2MB, and 1MB, respectively. Then one has to establish two backup LSP's, as BLSP1 (11-13-12) and BLSP2(11-14-12) in the drawing. The backup LSP BLSP1 is used to protect the LSP's LSP1 and LSP2 (3M+2M=5M). The other backup LSP BLSP2 is used to protect LSP3. When the backup LSP's are not enough, the network device should send out a warning message.

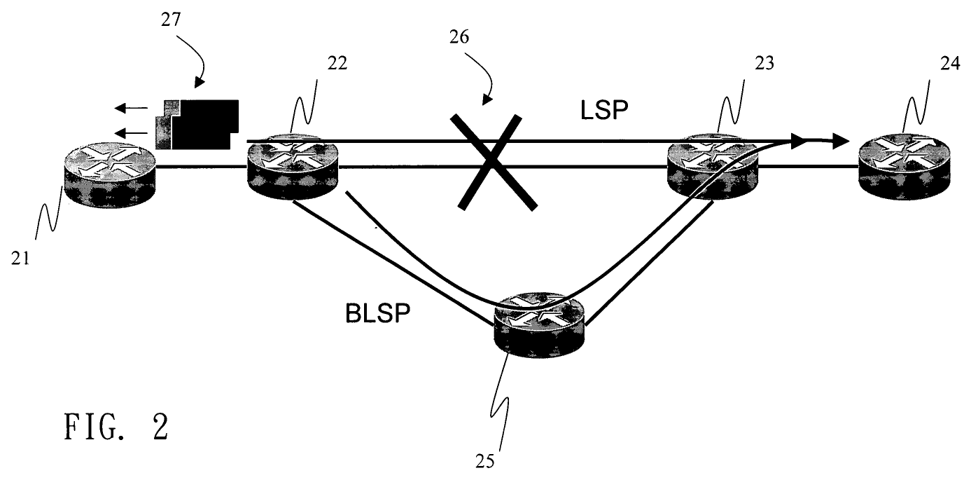

As shown in FIG. 2, the packets from the router 21 to the router 24 are transmitted via the LSP (21-22-23-24) normally. If a breaking 26 occurs, the router 22 before the breaking 26 first switches the path to the predefined backup LSP BLSP (21-22-25-23-24). Therefore, the network service is not interrupted by the breakdown. The router 22 waits a default time Tfail. If the path is still broken after then, the router 22 sends a fault information signal 27 to the ingress router 21. To prevent transmission failure of the fault information signal 27, at least two fault information signals 27 can be simultaneously sent to the router 21 to increase the reliability.

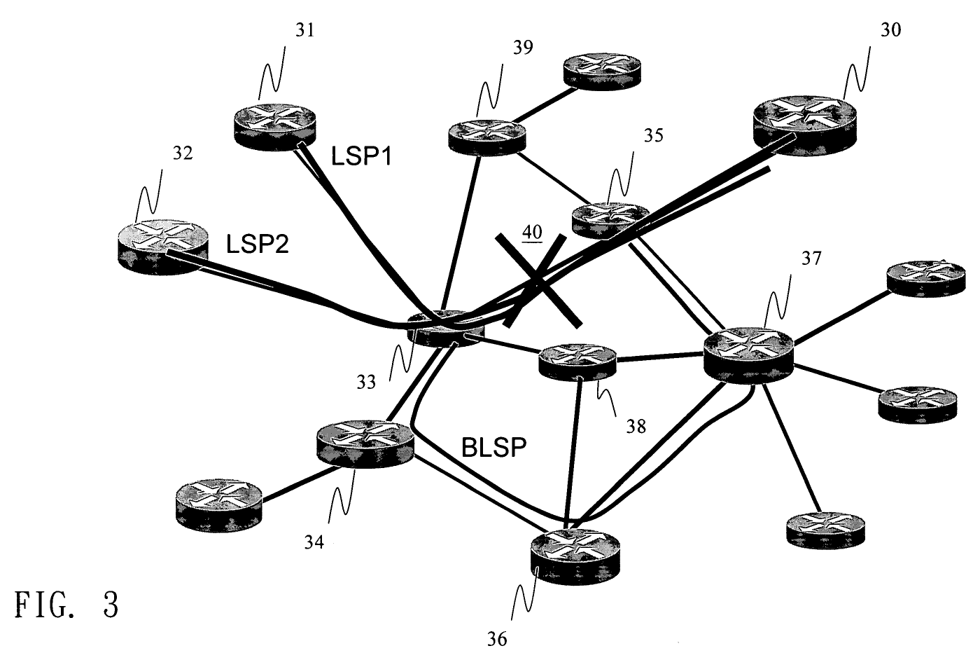

In the following, we use an embodiment to explain the invention. With reference to FIG. 3, if a packet is to be transmitted from the ingress router 31 to a egress router 30, it normally takes LSP 1 (31-33-35-30). For another packet from an ingress router 32 to the egress router 30, it takes LSP2 (32-33-35-30). In this example, the default backup LSP between the router 33 and the router 35 is through the routers 33-36-37-35.

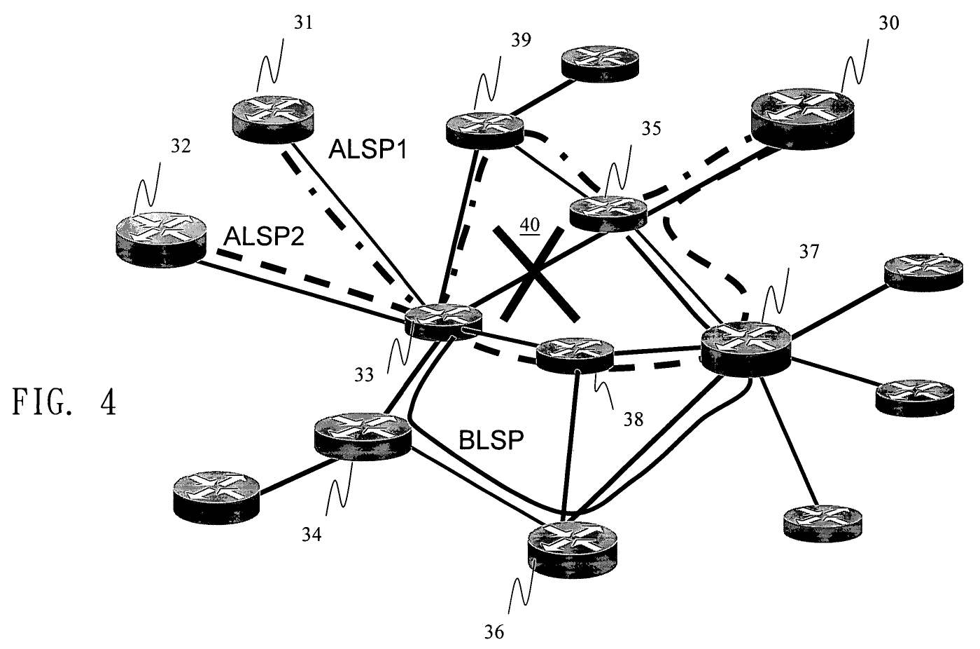

If a breaking 40 occurs between the router 33 and the router 35, the router 33 first switches packets to the backup LSP BLSP which prevents network service interruptions. If the network is not recovered after a default failure time Tfail, the router 33 sends out an fault information signal to the ingress routers 31, 32 (not shown). The same fault information signals can be send twice to increase the reliability. Since the backup LSP BLSP is defined beforehand and has no bandwidth reservation, it is not optimal (see FIG. 4). Therefore, when the ingress router 31 receives the fault information signal, it computes to obtain an auxiliary backup LSP ALSP1 according to the current network resources. As shown in the drawing, the ingress router 31 uses ALSP1 (33-39-35) to transmit packets to the egress router 30. Likewise, the ingress router 32 computes to obtain an auxiliary backup LSP ALSP2 to transmit packets to the egress router 30 via the route 33-34-36-37-35. Therefore, the invention rearranges backup LSP's after the breakdown. Since the rearrangement is done after a default failure time Tfail when the network becomes stable, the auxiliary backup LSP's ALSP1 and ALSP2 actually optimizes the backup LSP's.

They increase the bandwidth utilization and lower the CPU processing loads (the number of auxiliary backup LSP's is determined by the originally protected LSP's).

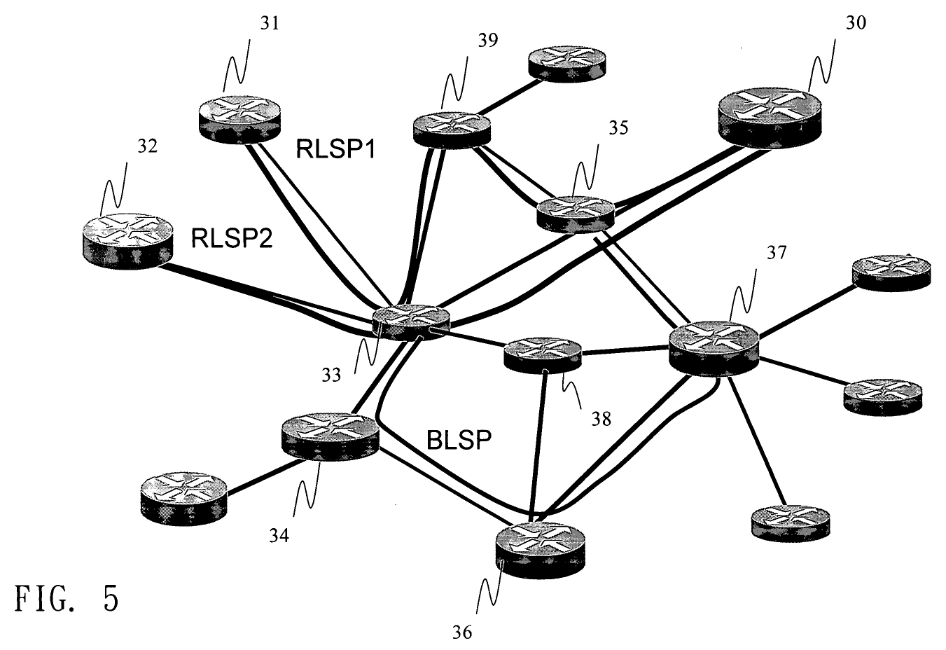

With reference to FIG. 5, when the breaking 40 is fixed, the system waits for a default available time Tavailable. After then, the router 33 (the closest one before the breaking 40) transmits a recovery signal to the ingress routers 31, 32. To increase the reliability, it can simultaneously send the recovery signal twice. The ingress router 31 rearranges new LSP's. As shown in the drawing, the system obtains a restored LSP RLSP1 that transmits packets to the egress router 30 via the routers 33, 39, 35. Likewise, the ingress router 32 also rearranges to obtain a restored LSP RLSP2 that transmits packets to the egress router 30 via the routers 33, 35. It is possible that the original path is also an optimized one.

Since no bandwidth is reserved for the backup LSP's in advance and only some backup LSP's with no bandwidth reservation are needed between two routers, the method has a higher bandwidth utilization and lower CPU processing overhead. On the other hand, because the backup LSP's with no bandwidth reservation are established in advance, the transmitted data can be immediately switched to the backup LSP's once there is an error in the network. Thus, the service interrupted time is short. The real backup LSP (the auxiliary LSP) is searched for after a certain period when the network becomes more stable. Therefore, a backup LSP can be found to optimize the network utilization. Even if the auxiliary backup LSP search fails, there is still a backup LSP with no bandwidth reservation that can be used to continue the network service.

Certain variations would be apparent to those skilled in the art, which variations are considered within the spirit and scope of the claimed invention.

1. A method for multi-protocol label switching (MPLS) link protection comprising the steps of:
checking that a label switching path (LSP) breaks down;
redirecting the LSP to a backup LSP with no bandwidth reservation;
rearranging to obtain an auxiliary backup LSP according to the current resource distribution in the MPLS network;
checking if the broken LSP is recovered; and
restoring the LSP.

2. The method of claim 1, wherein in the step of checking that a label switching path (LSP) breaks down a router before the breaking point sends out a fault information signal to an ingress router of the LSP.

3. The method of claim 2, wherein the router before the breaking point simultaneously sends at least two of the fault information signals.

4. The method of claim 1, wherein each of the default backup LSP's is defined according to the transmission capacities of the LSP and of the backup LSP.

5. The method of claim I further comprising the step of waiting a default failure time before the step of rearranging to obtain an auxiliary backup LSP according to the current resource distribution in the MPLS network.

6. The method of claim 1, wherein in the step of checking if the broken LSP is recovered a router before the breaking point sends a recovery signal to an ingress router of the LSP.

7. The method of claim 6, wherein the router before the breaking point simultaneously sends two of the signals.

8. The method of claim I further comprising the step of waiting a default available time before the step of restoring the LSP.

9. The method of claim 1, wherein the step of restoring the LSP rearranges to obtain a restored LSP according to the current resource distribution of the MPLS network and redirects the LSP to the restored LSP.
